(19) United States
(12) Patent Application Publication
(10) Pub. No.: US 2018/0089325 A1
(43) Pub. Date: Mar. 29, 2018

(54) Method, Apparatus and Client of Processing Information Recommendation

(71) Applicant: Alibaba Group Holding Limited, Grand Cayman (KY)

(72) Inventors: Yuliang Yan, Hangzhou (CN); Jun Lang, Hangzhou (CN); Heng Huang, Hangzhou (CN); Yunchuan Wang, Hangzhou (CN); Ji Mou, Hangzhou (CN)

(21) Appl. No.: 15/715,983

(22) Filed: Sep. 26, 2017

(30) Foreign Application Priority Data
Sep. 26, 2016 (CN) 201610852965.2

(51) Int. Cl. G06F 17/30; G06N 5/04; G06N 7/00; H04L 29/08; G06F 17/20

(52) U.S. Cl. CPC G06F 17/30867; G06N 5/04; G06F 17/20; H04L 67/22; H04L 67/306; G06N 7/005

(57) ABSTRACT

A method, an apparatus and a client of processing information recommendation are disclosed. The method includes expanding a search term into at least one search sentence based on a preconfigured information corpus in response to determining that the search term is a broad search term; obtaining recommended information that matches the search sentence from a selected information set; and presenting at least one piece of the recommended information. Using the method or apparatus embodiment of the present disclosure, recommended information matching a search sentence may be pushed to a user. The recommended information not only enriches the space of selection for the user, but also provides additional search guidance to the user.

### CROSS REFERENCE TO RELATED PATENT APPLICATIONS

This application claims foreign priority to Chinese Patent Application No. 201610852965.2, filed on Sep. 26, 2016, entitled “Method, Apparatus and Client of Processing Information Recommendation,” which is hereby incorporated by reference in its entirety.

### TECHNICAL FIELD

The present disclosure is related to the field of data processing technologies, and particularly, to methods, apparatuses and clients of processing information recommendation.

### BACKGROUND

Information recommendation technologies may provide relevant guidance to a user based on search information of the user, and may further help the user to make a final decision. In general, the information recommendation technologies are widely employed in the product search field. Based on search terms provided by a user, the information recommendation technologies can present product information that matches the search terms to the user for user selection. However, on many occasions, users may only provide a search term that includes relatively little effective information, such as “new lady fashion,” “mobile phone,” etc. Due to the relatively little effective information, an intent of a user is generally difficult to understand, and a large amount of useless information is usually pushed for recommendation.

In existing technologies, methods of recommending information for a search term having little effective information usually rely on a search log of a user, and expand the search term into a search term having a larger amount of information. For example, “mobile phone” is expanded into “Apple mobile phone”, to increase a search precision. However, users do not have a clear browsing target in many situations. In these cases, providing precise product information to the users may violate search intentions of the users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure aims to provide a method, an apparatus and a client of processing information recommendation, to enrich the scope of selection for a user, and to further provide additional search guidance to the user.

The method, the apparatus and the client of processing information recommendation provided by the present disclosure are implemented as shown hereinafter.

A method of processing information recommendation includes expanding a search term into at least one search sentence based on a preconfigured information corpus in response to determining that the search term is a broad search term; obtaining recommended information that matches the search sentence from a selected information set; and providing at least one piece of the recommended information for presentation.

An apparatus of processing information recommendation includes a broad term expansion unit used for expanding a search term into at least one search sentence based on a preconfigured information corpus in response to determining that the search term is a broad search term; recommended information acquisition unit used for obtaining recommended information that matches the search sentence from a selected information set; and information presentation unit used for providing at least one piece of the recommended information for presentation.

A client includes a storage device used for storing a preconfigured information corpus and a selected information set; processor(s) used for expanding a search term into at least one search sentence based on a preconfigured information corpus in response to determining that the search term is a broad search term, and obtaining recommended information that matches the search sentence from a selected information set; a display used for providing at least one piece of the recommended information for presentation.

The disclosed method, apparatus and client can expand a search term into at least one search sentence after determining that the search term is a broad search term, obtain recommended information that matches the search sentence from a selected information set, and provide at least one piece of the recommended information for display. On the one hand, expanding the search term into a search sentence can preserve a search topic of a user based on the search term. On the other hand, expanding the search term based on a provided information corpus can not only increase effective information of the search term, but also cause the expanded search sentence to be closer to information. Compared with existing technical methods that expand a broad search term based on a search log of a user and recommend precise information having a relatively small scope to the user, the present embodiments can push recommended information that matches the search sentence to the user. The recommended information not only increases the scope of selection for the user, but also provides further search guidance to the user.

### BRIEF DESCRIPTION OF THE DRAWINGS

In order to describe technical solutions of the embodiments of the present disclosure more clearly, the accompanying drawings are briefly described herein. Apparently, the accompanying drawings represent merely a few embodiments recorded in the present disclosure. Based on these accompanying drawings, one of ordinary skill in the art can obtain other drawings without making any creative effort.

FIG. 1 shows a flowchart of a method of processing information recommendation in accordance with an embodiment provided in the present disclosure.

FIG. 2 shows a flowchart of a method for textually analyzing a broad term in accordance with an embodiment provided in the present disclosure.

FIG. 3 shows a flowchart of a method of expanding a broad term in accordance with an embodiment provided in the present disclosure.

FIG. 4 shows a flowchart of a method of generating a search sentence in accordance with an embodiment provided in the present disclosure.

FIG. 5 shows a flowchart of a method of selecting search sentences in accordance with an embodiment provided in the present disclosure.

FIG. 6 shows a flowchart of a method of presenting information guidance in accordance with an embodiment provided in the present disclosure.

FIG. 7 shows a flowchart of a method of selecting recommended information in accordance with an embodiment provided in the present disclosure.

FIG. 8 shows a search sentence and a search phrase presented in a user interface in an application scenario in accordance with the present disclosure.

FIG. 9 shows an information set presented in a user interface in an application scenario in accordance with the present disclosure.

FIG. 10 shows a diagram of a modular structure of an information recommendation processing apparatus in accordance with an embodiment provided in the present disclosure.

FIG. 11 shows a diagram of a modular structure of a broad term expansion unit in accordance with an embodiment provided in the present disclosure.

FIG. 12 shows a diagram of a modular structure of a broad term expansion unit in accordance with another embodiment provided in the present disclosure.

FIG. 13 shows a diagram of a modular structure of a search sentence forming unit in accordance with an embodiment provided in the present disclosure.

FIG. 14 shows a diagram of a modular structure of an information recommendation processing apparatus in accordance with another embodiment provided in the present disclosure.

FIG. 15 shows a diagram of a modular structure of an information recommendation processing apparatus in accordance with another embodiment provided in the present disclosure.

FIG. 16 shows a diagram of a modular structure of an information recommendation processing apparatus in accordance with another embodiment provided in the present disclosure.

FIG. 17 shows a diagram of a modular structure of a recommended information acquisition unit in accordance with an embodiment provided in the present disclosure.

FIG. 18 shows a diagram of a modular structure of a client in accordance with an embodiment provided in the present disclosure.

FIG. 19 shows a structural diagram of the apparatus as described in FIGS. 10 and 14-16 in more detail.

### DETAILED DESCRIPTION

In order to allow one skilled in the art to understand the technical solutions of the present disclosure in a better manner, the technical solutions in the embodiments of the present disclosure are described in a clear and comprehensive manner in conjunction with the accompanying drawings in the embodiments of the present disclosure. Apparently, the described embodiments merely represent some and not all of the embodiments of the present disclosure. Based on the embodiments of the present disclosure, all other embodiments that are obtained by one of ordinary skill in the art without making any creative effort shall belong to the scope of protection of the present disclosure.

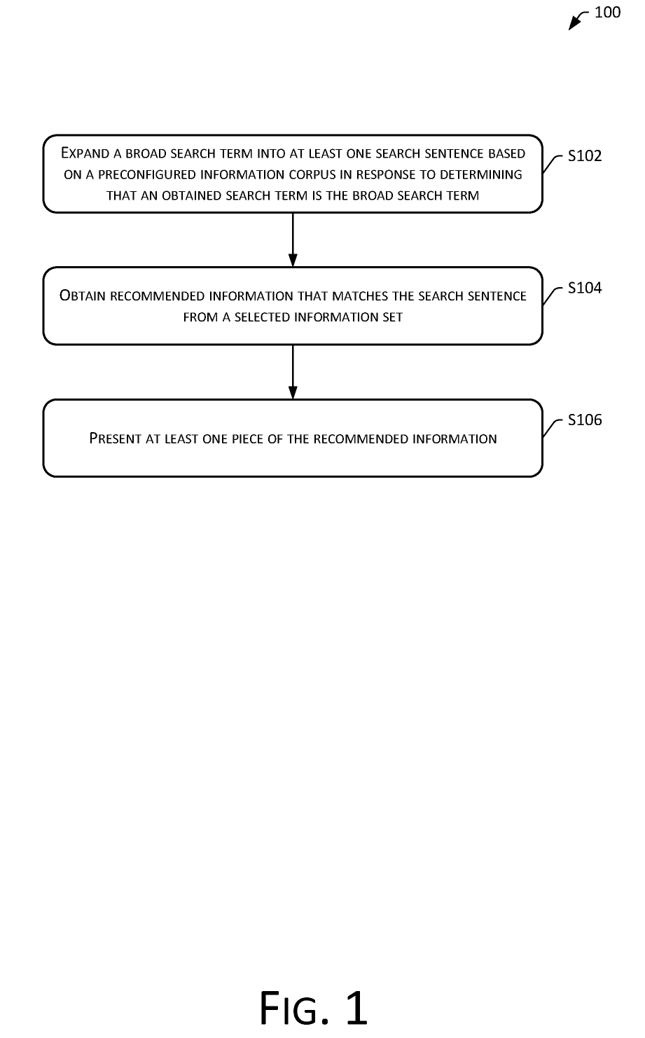

Methods of processing information recommendation in accordance with the present disclosure are described in detail herein in conjunction with the accompanying drawings. FIG. 1 shows a flowchart of a processing method 100 of information recommendation in accordance with an embodiment provided in the present disclosure. Although the present disclosure provides method operations as shown in the following embodiments or accompanying drawings, the methods may include more or fewer number of operations according to common practices or without the need of any creative effort. In an event that no causal relationship that is logically necessary exists between operations, an order of execution of these operations is not limited to an order of execution as provided in the embodiments of the present disclosure. During a process of information recommendation or an execution of an apparatus, a method may be performed according to an order described in the embodiments or accompanying drawings, or may be performed in a parallel manner (for example, in an environment having parallel processing devices or multi-thread processing).

Details of an exemplary method 100 of processing information recommendation provided by the present disclosure are shown in FIG. 1. The method 100 may include the following operations.

S102 expands a search term into at least one search sentence based on a preconfigured information corpus in response to determining that the search term is a broad search term.

In implementations, a server may determine an obtained search term as a broad search term. The server may include hardware component(s) having data processing functionalities and software component(s) needed for driving the hardware component(s). In implementations, a user inputs a search term in a client. Upon detecting the search term, the client sends a search request to the server. The search request includes at least the search term. In implementations, after receiving the search term, the server may determine whether the search term is a broad search term. In implementations, a broad search term may be a search term having a relatively small amount of effective information or a wide scope of meaning according to a predetermined measure. By way of example and not limitation, a number of times of browsing associated with the search term and a number of words included in the search term may be used for determining whether the search term is a broad search term. In a particular scenario as shown in Table 1, a user inputs a search term “cycling” in a XX shopping client. After a statistical analysis at a backend database, the number of times of browsing a page with a product name that includes “cycling” within the latest week is 2307, the number of complete product transactions through user searches of “cycling” within the latest week is 2, and the number of word segments obtained for “cycling” is 1. On the other hand, for a search term “woman's thick fleece leggings”, a statistical analysis at the backend database obtains the number of times of browsing a page with a product name that includes “woman's leggings with thick fleece” within the latest week to be 350, the number of complete product transactions through user searches of “woman's leggings with thick fleece” within the latest week to be 15, and the number of word segments obtained for “woman's leggings with thick fleece” to be 5. Based on the number of times of browsing, the number of complete transactions and the number of word segments, respective broad term index values for the search terms “cycling” and “woman's leggings with thick fleece” are calculated to be 0.83 and 0.37 using a weighted sum algorithm. A search term is determined as a broad search term if a broad term index value is greater than 0.75. Therefore, a determination is made that “cycling” is a broad search term, and “woman's leggings with thick fleece” is not a broad search term.

TABLE 1
Broad search term evaluation table

| | | | | Broad | |
|---|---|---|---|---|---|
| | Number of | Number of | Number of | term | Whether to |
| | times of | complete | word | index | be a broad |
| Search term | browsing | transaction | segments | value | search term |
| Cycling | 2307 | 2 | 1 | 0.83 | Yes |
| Woman's | 350 | 15 | 5 | 0.37 | No |
| leggings | | | | | |
| with | | | | | |
| thick fleece | | | | | |

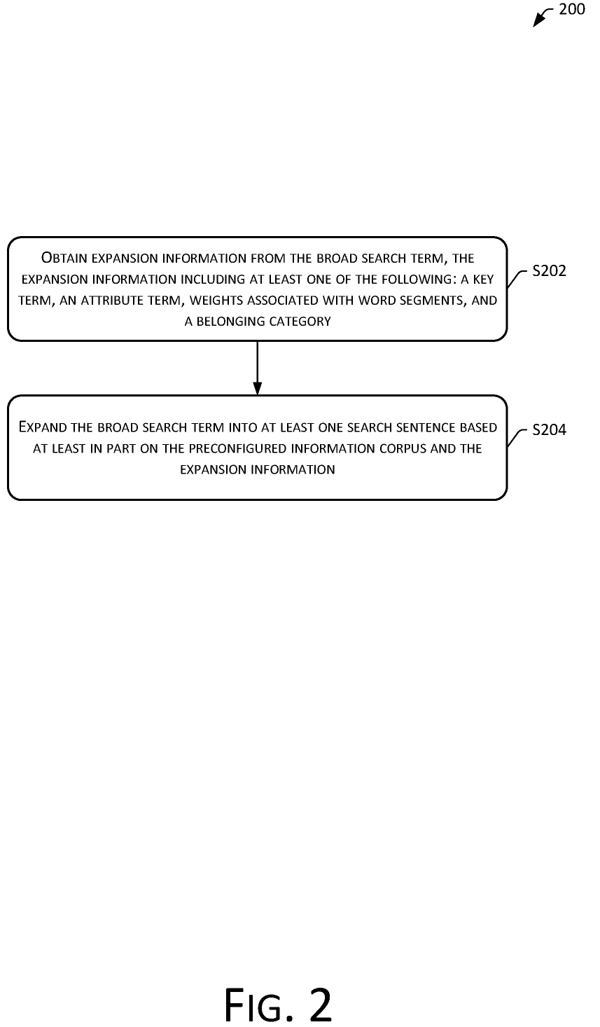

In implementations, the broad search term can be expanded into at least one search sentence. The search sentence may be a sentence including information of the broad search term. In implementations, a textual analysis may first be performed on the broad search term, and the broad search term may then be expanded into at least one search sentence. FIG. 2 shows a flowchart of a method 200 of textually analyzing a broad term in accordance with an embodiment provided in the present disclosure. As shown in FIG. 2, expanding the broad search term into the at least one search sentence includes the following operations.

S202 obtains expansion information from the broad search term, the expansion information including at least one of the following: a key term, an attribute term, weights associated with word segments, and a belonging category.

S204 expands the broad search term into at least one search sentence based at least in part on the preconfigured information corpus and the expansion information.

In implementations, expansion information may be obtained from the broad search term. The expansion information includes at least one of the following: a key term, an attribute term, weights associated with word segments, and a category to which it belongs. The key term may be a word/phrase that is most representative of search content of the broad search term. In particular, the key term may be obtained by matching with a dictionary. For example, for a broad search term of “stylish cycling equipment”, “cycling equipment” may be obtained as a key term of this broad search term. In a subsequent expansion process of the broad search term, the key term can be used as a base term for performing the expansion. The attribute term may manifest personalized information of the search term. Specifically, the attribute term may be obtained using a conditional random field algorithm. For example, “stylish” may be extracted as an attribute term for the broad search term of “stylish cycling equipment”. This attribute term may be used as a reference for personalized expansion in the subsequent expansion process of the broad search term. The weights associated with the word segments are respective weights of the word segments included in the broad search term, and can be referenced to weight information of words recorded in a preconfigured word database. For example, a descending order of weights associated with words segments “stylish”, “cycling” and “equipment” in the broad search term of “stylish cycling equipment” is “equipment”>“cycling”>“stylish”. Word segment(s) having a larger weight may further be used as base term(s) for performing expansion in the subsequent expansion process of the broad search term. The category to which the broad search term belongs may be obtained using a model such as Bayesian, Maximum Entropy, etc. After the category to which the broad search term belongs is obtained, a space of expansion of the broad search term may be reduced. For example, using a Bayesian model, the category to which the broad search term of “stylish cycling equipment” belongs is obtained as outdoor activities>cycling and fishing.

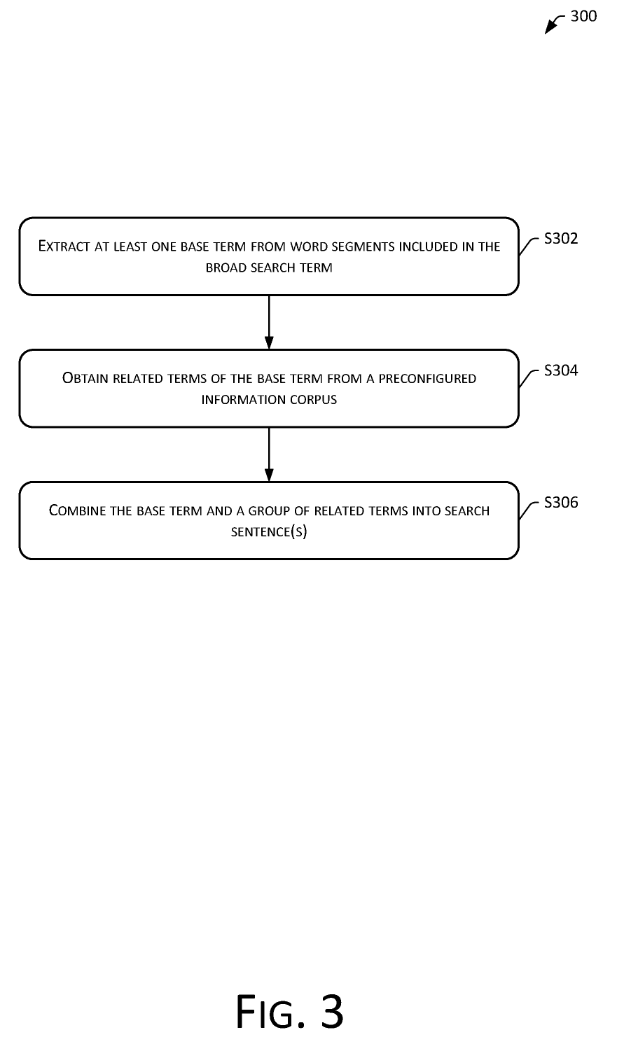

In implementations, a method of expanding a broad search term is further provided. FIG. 3 shows a flowchart of a method 300 of expanding a broad search term in accordance with an embodiment of the present disclosure. As shown in FIG. 3, expanding the broad search term into the at least one search sentence may include the following operations.

S302 extracts at least one base term from word segments included in the broad search term.

In implementations, at least one base term may be extracted from word segments included in the broad search term. The base term may be used as a basis for expanding the broad search term. For example, in implementations, the base term may be the key term of the broad search term. In another embodiment of the present disclosure, the base term may further be a word segment having the largest weight among the word segments included in the broad search term.

In implementations, the base term may further include a synonym or a near-synonym of the word segment. In a real scenario, broad search terms having a low frequency are usually provided due to different language expressing habits of users. For example, although a word segment of “hostel” for a broad search term of “Hangzhou hostel” has a relatively low use frequency, a search intent of a user may be determined based on synonyms (such as “hotel”, “inn”, etc.) of “hostel”. In a particular implementation, synonyms or near-synonyms of the word segment may be obtained from a preset synonym/near-synonym database. In one aspect, the present embodiment can explore the diversity of a broad search term. In another aspect, the expansibility of a low-frequency term is increased.

S304 obtains related terms of the base term from a preconfigured information corpus.

In implementations, terms related to the base term may be obtained from a preconfigured information corpus. The information corpus may be a language model that is created based on a large amount of information. The information corpus may establish association relationships among terms based on information such as frequencies of association among the terms in the information obtained from statistics. It is noted that the information may include information of a variety of different fields such as news, supply and demand, trends, technologies, policies, comments, opinions, academics, etc. The information may provide a certain degree of use value to users, and may receive feedback information from the users. In implementations, terms related to the base term may be obtained based on N-gram model. The N-gram model may perform term vector computation on offline information and collect terms having similar information into a same cluster. Therefore, terms having a relatively large degree of relevancy with the base term may be obtained based on the N-gram model. For example, terms related to a term of “cycling”, such as “love”, “outdoor”, “weekend”, “outing”, “glasses”, “moment”, etc., may be obtained from an information corpus based on an N-gram model.

S306 combines the base term and a group of related terms into search sentence(s).

In implementations, the base term and the group of related terms may be combined into search sentence(s). For example, based on terms related to “cycling” that are obtained from an information corpus for a base term “cycling”, search sentences such as “love cycling equipment necessary glasses”, “outdoor cycling clothes selection weekend outing”, “love cycling equipment pretension”, etc., can be formed.

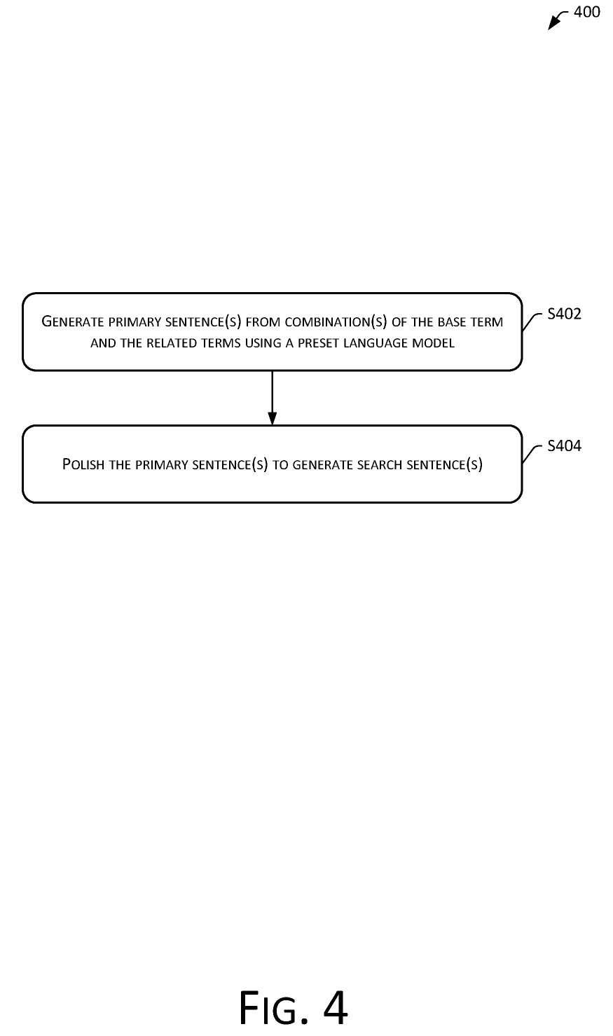

Generally, if the base term is merely combined with the group of related terms, a search sentence obtained thereby usually has grammatical errors, and has a relatively high degree of confusion. However, data included in the information usually includes sentences with a clear semantic meaning and a correct word order. If a degree of confusion of a search sentence is relatively high, it will be difficult to obtain relatively accurate and high-valued information at a later stage. The present embodiment can generate a search sentence after polishing a primary sentence that is formed. FIG. 4 shows a flowchart of a method 400 of generating a search sentence in accordance with an embodiment of the present disclosure. As shown in FIG. 4, combining the base term with the group of related terms to form the search sentence(s) may include the following operations.

S402 generates primary sentence(s) from combination(s) of the base term and the related terms using a preset language model.

S404 polishes the primary sentence(s) to generate search sentence(s).

In implementations, a preset language model may be used to generate primary sentence(s) from combination(s) of the base term and the related terms. For example, primary sentences, such as “love cycling equipment necessary glasses”, “outdoor cycling select weekend outing”, “love cycling equipment fit”, etc., may be formed based a base term of “cycling” and related terms of “cycling” that are obtained from an information corpus. As can be seen, respective degrees of confusion of these primary sentences are relatively high. In implementations, primary sentences may be polished to generate search sentences using a language model, such as an N-gram. For example, “love cycling equipment fit” is polished to become “necessary glasses equipment for those who love cycling”. “outdoor cycling take weekend outing” is polished to become “select weekend to go out for outdoor cycling”. “love cycling equipment fit” is polished to become “does your equipment fit for you who love cycling”.

In implementations, primary sentences that are formed from a base term and related terms are polished, thus greatly reducing respective degrees of confusion of search sentences so generated, and facilitating to obtain higher-valued information that matches with the search sentences from an information set at a later stage.

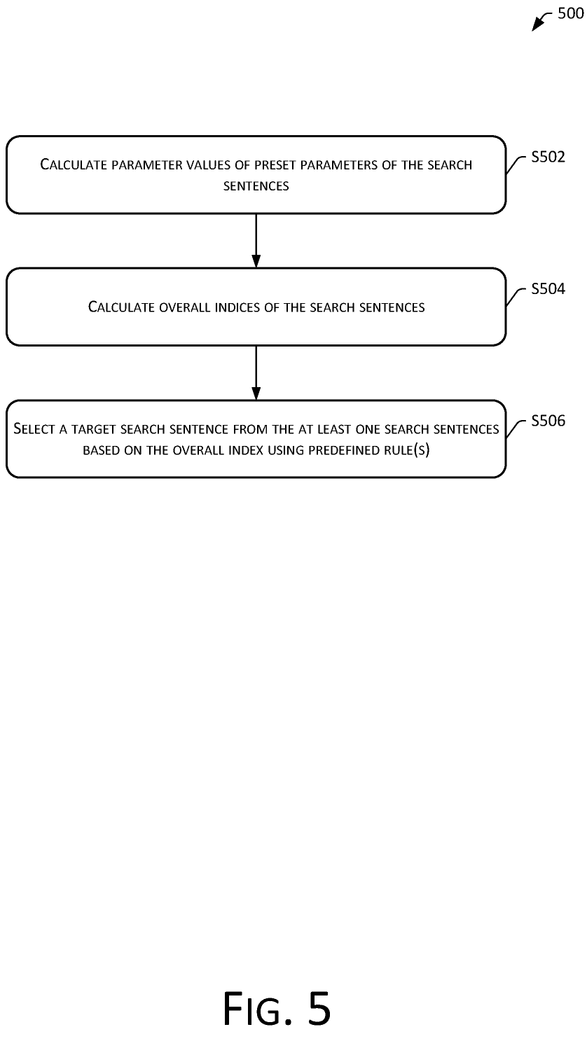

In implementations, filtering may further be performed on the search sentences. FIG. 5 shows a flowchart of a method 500 of selecting a search sentence in accordance with an embodiment of the present disclosure. As shown in FIG. 5, the method 500 may include the following operations.

S502 calculates parameter values of preset parameters of the search sentences, the preset parameters including at least one of the following types: a degree of semantic confusion, a user information matching index, and an information recall index.

In implementations, the search sentences may be filtered based on preset parameters of the search sentences. Specifically, the preset parameters may include at least one of the following types: a degree of semantic confusion, a user information matching index, and an information recall index. A degree of semantic confusion may be obtained based on a language model. A value of the degree of semantic confusion may be used for determining a degree of semantic accuracy. The more accurate the semantic meaning is, the lower the degree of semantic confusion is. A user information matching index may be used for determining a degree of matching between a search sentence and user personalized information. In the present disclosure, personalized information of a user that is stored offline in a server may be used to obtain information such as basis information, an attribute preference, a product preference of the user. A user information matching index may be calculated based on content of a search sentence and personalized information of a user. An information recall index may be used for determining an amount and a quality of information related to a search sentence. A higher information recall index means a larger amount and a higher quality of information of a search sentence.

S504 calculates overall indices of the search sentences based on the parameter values and preset weight indices of the preset parameters.

In implementations, an overall index of a search sentence may be calculated based on parameter vales and preset weight indices of the preset parameters. For example, an overall index may be calculated using a weighted sum algorithm, and may specifically be calculated using the following equation (1):

Overall Index=Weight Value 1×Degree of Semantic Confusion+Weight Value 2×User Information Matching Index+Weight Value 3×Information Recall Index (1)

The weight indices of the preset parameters may be defined based on predefined parameter impact factors in a real application scenario. For example, the higher the degree of semantic confusion is, the less clear the semantic meaning of a search sentence is. Therefore, the weight value 1 in the equation (1) needs to be a negative value.

S506 selects a target search sentence from the at least one search sentences based on the overall index using predefined rule(s).

In implementations, the overall indices that are obtained may be used for selecting a target search sentence from the at least one search sentence using predefined rule(s). In implementations, the predefined rule(s) may be set as: selecting target sentence(s) that is/are greater than a first threshold value and/or ranked prior to a second threshold value from the at least one search sentence, after the at least one search sentence is arranged according to a descending order of the overall indices.

In implementations, search sentence(s) having an overall index greater than a first threshold value and/or having a rank of an overall index prior to a second threshold value can be treated as target search sentence(s). This not only ensures the diversity nature of target sentences, but also ensures high overall indices of the target search sentences, thus improving the efficiency of information matching at a later stage.

Apparently, obtaining recommended information that matches the search sentence from a selected information set may correspondingly include obtaining recommended information that matches the target search sentences from the selected information set.

It is noted that search sentences may be presented after the search sentences are generated. For example, search sentences may be presented below a search input field of a client for a user to select.

In implementations, a base term may be extracted from a broad search term, and terms related to the base term may be obtained from an information corpus. The base term and the related terms may be combined to form search sentences. On the one hand, generating a search sentence from an originally broad search term preserves a search topic of a user. On the other hand, performing an expansion of the base term based on a provided information set not only enriches search content of the base term, but also causes the search sentence that is obtained from the expansion to be closer to the information.

S104 obtains recommended information that matches the search sentence from a selected information set.

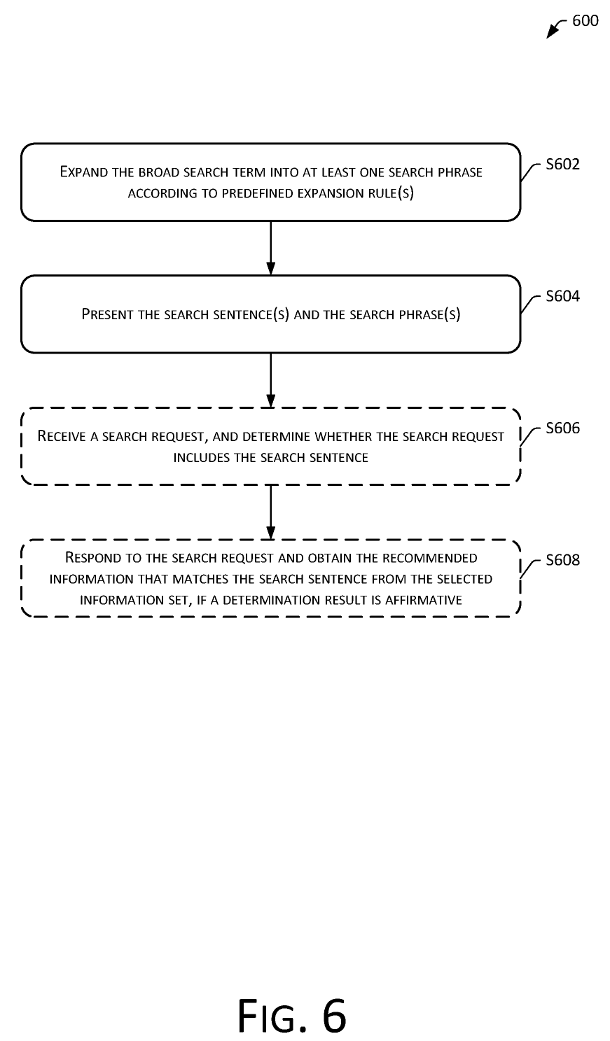

In implementations, in order to provide more comprehensive information to a user, not only the search sentence is presented to the user, but search phrases that are obtained by expanding the broad search term are also presented to the user. FIG. 6 shows a flowchart of a method 600 of presenting guidance information in accordance with an embodiment of the present disclosure. As shown in FIG. 6, after expanding the broad search term into the at least one search sentence, the method 600 may include the following operations.

S602 expands the broad search term into at least one search phrase according to predefined expansion rule(s).

S604 presents the search sentence(s) and the search phrase(s).

In implementations, the predefined expansion rule(s) may include expanding the broad search term into search terms having more information based on a search log of the user. For example, a broad search term of “cycling” is expanded into phrases or combinations of phrases such as “cycling clothes”, “cycling gloves”, “cycling helmet”, “summer cycling equipment”. After expanding into the search phrases, the search sentence(s) and the search phrase(s) may be presented. Similarly, the search sentence(s) and the search phrase(s) may be presented below the search input field for the user to select.

In implementations, more complete guidance information may be presented from two perspectives—information and precise search terms—based on the broad search term, to enhance the experience of the user.

Correspondingly, as shown in FIG. 6, obtaining the recommended information that matches the search sentence(s) from the selected information set may include:

S606 receives a search request, and determines whether the search request includes the search sentence.

S608 responds to the search request and obtains the recommended information that matches the search sentence from the selected information set, if a determination result is affirmative.

In implementations, after presenting the search sentence(s) and the search phrase(s) to the user, the client may generate a search request and sends the search request to a server, if the user selects a search sentence or a search phrase. A search request includes at least one of a search sentence or a search phrase selected by the user. Upon receiving the search request, the server may determine whether the search request includes the search sentence. The server may respond to the search request and further obtain recommended information that matches the search sentence from the information set if a determination result is affirmative.

In implementations, the information set may include a set of information selected by the server, and may further include sets of information selected from storage systems that are different from the server. As described above, the information may include a variety of different types of information. The information may bring certain use values to the user, and may obtain feedback information from the user. In the process of obtaining the recommended information that matches the search sentence from the selected information set, a keyword of the search sentence may be extracted. At least one piece of recommended information that is associated with the keyword may be found from the information set based on the keyword using a method such as a reverse index. For example, for a search sentence of “does your equipment fit for you who love cycling”, keywords of the search sentence that are obtained are “cycling” and “equipment”. Recommended information such as “cycling equipment along with you”, “does your equipment fit for you who love cycling”, etc., that matches the keywords are obtained from the provided information set.

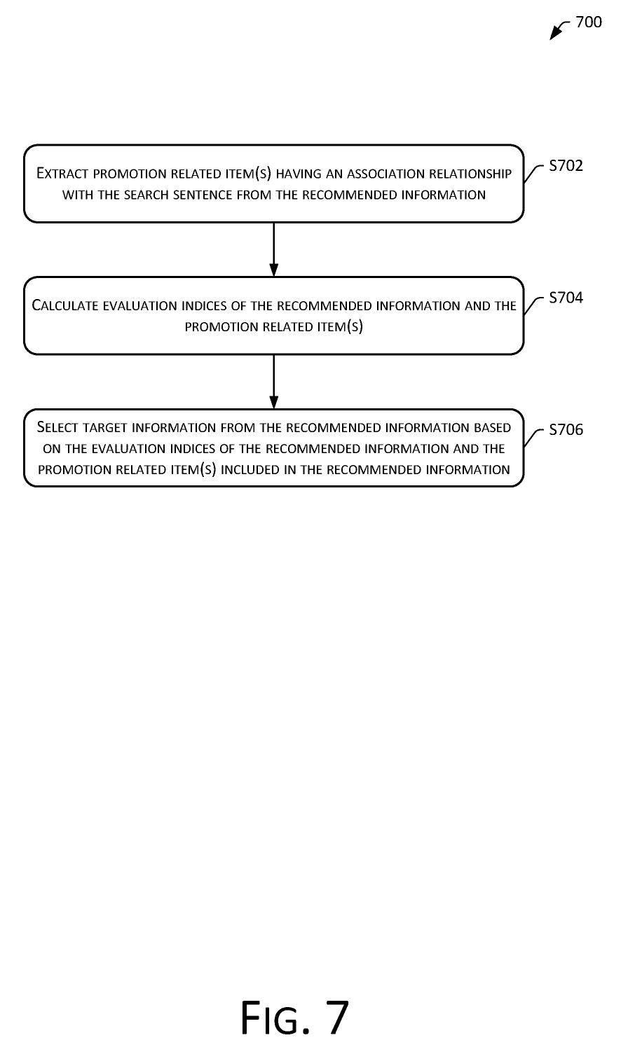

In a real scenario, a limited amount of information is usually presented to a user. If a larger amount of recommended information that matches the search sentence is obtained from the provided information set, filtering may be performed for the recommended information. In implementations, a method of selecting recommended information is provided. FIG. 7 shows a flowchart of a method 700 of selecting information in accordance with an embodiment of the present disclosure. As shown in FIG. 7, after obtaining the recommended information that matches the search sentence from the selected information set, the method 700 may include the following operations.

S702 extracts promotion related item(s) having an association relationship with the search sentence from the recommended information.

S704 calculates evaluation indices of the recommended information and the promotion related item(s).

S706 selects target information from the recommended information based on the evaluation indices of the recommended information and the promotion related item(s) included in the recommended information.

The information may not only include textual content that corresponds with the topic, but also provide corresponding promotion information. For example, information in a shopping platform usually has product links related to information entities. After extracting promotion related item(s) having an association relationship with the search sentence from the recommended information, evaluation indices of the recommended information and the promotion related item(s) may also be calculated. An evaluation index of the recommended information may be determined based on parameters such as the textual quality, the click rate, the number of comments, the number of times of being favorite, etc. An evaluation index of a promotion related item may be determined based on parameters such as the number of clicks associated with the promotion related item, and the relevance with the search sentence, etc. Based on the evaluation indices of the recommended information and the promotion related item(s) included in the recommended information, target information may be selected from the at least one piece of recommended information. A particular selection method may be referenced to the method of selecting a search sentence as described above. Based on the evaluation indices of the recommended information and the promotion related item(s), a weighted sum algorithm is used to obtain an overall index of the recommended information, and target information is selected using the overall index according to the predefined rule(s). The predefined rule(s) can be referenced to S506, and is/are not repeatedly described herein.

In implementations, piece(s) of recommended information having a relatively high use value may be selected from multiple pieces of recommended information based on the quality of the recommended information.

S106 presents at least one piece of the recommended information.

In implementations, at least one piece of the obtained recommended information may be presented. In another embodiment of the present disclosure, presenting the at least one piece of the recommended information may include presenting target information and promotion related item(s) included in the target information after the target information is obtained, as shown in FIG. 7.

A method of presenting the recommended information may include a form of a list, with the target information and key information of the promotion related item(s) being presented in the list. By clicking related information or a promotion related item in the list, the user can directly enter into a content page of the information or the promotion related item.

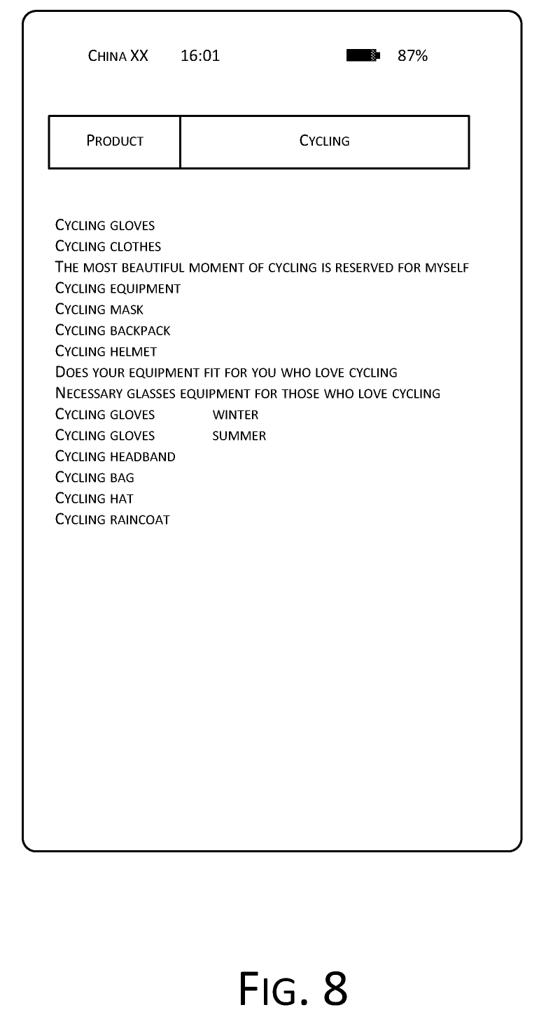

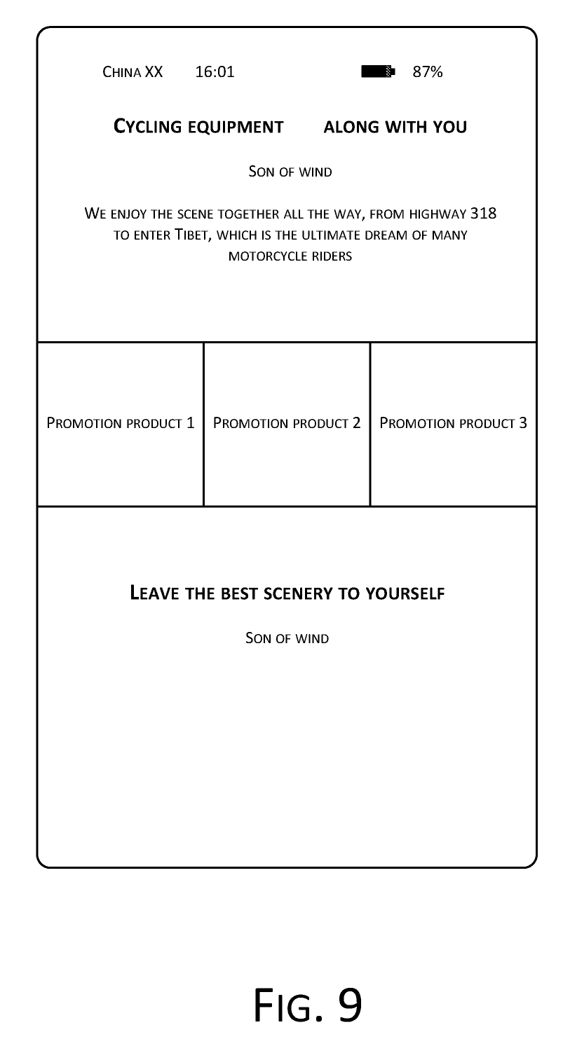

A particular scenario is used hereinafter for explaining the method in implementations. A user inputs a search term “stylish cycling” in a product input field in a shopping client. Based on parameters such as the number of times of page browsing, the number of complete product transactions, the number of word segments, etc., the search term “stylish cycling” is determined to be a broad search term. The broad search term “stylish cycling” is divided into two word segments “stylish” and “cycling”. After an analysis thereof, “cycling” is set as a key term of this broad search term, and “stylish” is set as an attribute term of the broad search term. In the current scenario, the key term is treated as a base term, and terms related to “cycling” are obtained from a preconfigured information corpus, which include such terms as “equipment”, “love”, “glasses”, “outdoor”, “weekend”, “outing”, “clothes”, “moments”, etc. Based on the base term “cycling” and the related terms that are obtained, search sentences as shown in Table 2 are formed. Table 2 further shows respective degrees of semantic confusion of the search sentences. In implementations, search sentences “outdoor cycling select weekend outing” and “around island cycling clothes with stars all the way” that have relatively high degrees of confusion may be filtered out. Corresponding values of degrees of semantic confusion, user information matching indices, information recall indices of search sentences, such as “necessary glasses equipment for those who love cycling”, “does your equipment fit for you who love cycling”, “the most beautiful moment of cycling is reserved for myself”, etc., are calculated. A table of correspondence relationships between the search sentences and preset parameters is generated and shown in Table 3. In the current scenario, matching indices of a search user with the search sentences can be calculated based on user information corresponding to the user. For example, personal information of a search user A is known to be “gender: male; age: 28; shopping power: strong; tags: travel, literature and art, music; shopping history: mountain bike, backpack, camera . . . .” Respective values of user information matching indices of the search sentences may be obtained based on the personal information of A. In the current scenario, values of information recall indices of the search sentences can also be calculated based on parameters that are associated with the search sentences, such as the number of pieces of information, the quality of the pieces of information, etc. Finally, weight values of the degrees of semantic confusion are set as −0.0001. Weight values of the user information matching indices are set as 0.5, and weight values of the information recall indices are set as 0.5. Respective overall indices of the search sentences are calculated according to the equation (1). Based on the overall indices, target search sentence(s) having an overall index greater than 0.3 and a rank of the overall index being before or at the third position is/are selected. Table 3 shows three search sentences that are target search sentences. In implementations, the broad search term may also be expanded into search terms having a larger amount of information based on a search log of the user. For example, “cycling” may be expanded into search phrases such as “cycling gloves”, “cycling clothes”, “cycling equipment”, “cycling mask”, etc., based on search popularities of search terms that are related to “cycling”. As shown in FIG. 8, the target search sentences and the search phrases may be presented below an input field. If the user clicks on a target search sentence, recommended information matching the search sentence is obtained from a selected information set. Table 4 is a table of correspondence relationships between target information and information evaluation scores. The target information is information that is selected based on evaluation indices of the recommended information that is obtained and promotion related items in the recommended information. Finally, the target information and product information that is advertised in the target information is presented to the user in a form of a list, as shown in FIG. 9.

TABLE 2
Table of correspondence between search sentences and degrees of
semantic confusion

| | Degree of |
|---|---|
| | semantic |
| Search sentence | confusion |
| necessary glasses equipment for those who love cycling | 528 |
| outdoor cycling select weekend outing | 1440 |
| around island cycling clothes with stars all the way | 2788 |
| does your equipment fit for you who love cycling | 651 |
| the most beautiful moment of cycling is reserved for myself | 480 |

TABLE 3
Table of correspondence relationships between search sentences and preset
parameters

| | Degree of | User | | |
|---|---|---|---|---|
| | semantic | information | Information | Overall |
| Search sentence | confusion | matching index | recall index | index |
| necessary glasses | 528 | 0.3 | 0.5 | 0.3472 |
| equipment for those | | | | |
| who love cycling | | | | |
| does your | 651 | 0.65 | 0.75 | 0.6349 |
| equipment fit for | | | | |
| you who love | | | | |
| cycling | | | | |
| the most beautiful | 480 | 0.8 | 0.7 | 0.702 |
| moment of cycling | | | | |
| is reserved for | | | | |
| myself | | | | |
| . . . | . . . | . . . | . . . | . . . |

TABLE 4
Table of correspondence relationships between target information and
information evaluation scores

| | | Advertised | |
|---|---|---|---|
| | Information | product | |
| | evaluation | evaluation | Overall |
| Information topic | score | score | score |
| Cycling equipment along with you | 0.75 | 0.9 | 1.65 |
| Reserve the most beautiful scenery | 0.85 | 0.6 | 1.45 |
| for myself | | | |
| Protect rider in winter cycling | 0.7 | 0.7 | 1.4 |

The present disclosure provides methods of processing information recommendation. When an obtained search term is determined as a broad search term, the broad search term can be expanded into at least one search sentence. Recommended information matching the search sentence is then obtained from a selected information set, and at least one piece of the recommended information is presented at the end. On the one hand, a search topic of a user can be preserved based on the originally broad search term. On the other hand, expanding the broad search term based on a provided information corpus can not only increase effective information of the broad search term, but also cause the expanded search sentence to be closer to information. Compared with methods that expand a broad search term based on a search log of a user and recommend precise information having a relatively small scope to the user in existing technologies, the present embodiments can push recommended information that matches the search sentence to the user. The recommended information not only increases the space of selection for the user, but also provides further search guidance to the user.

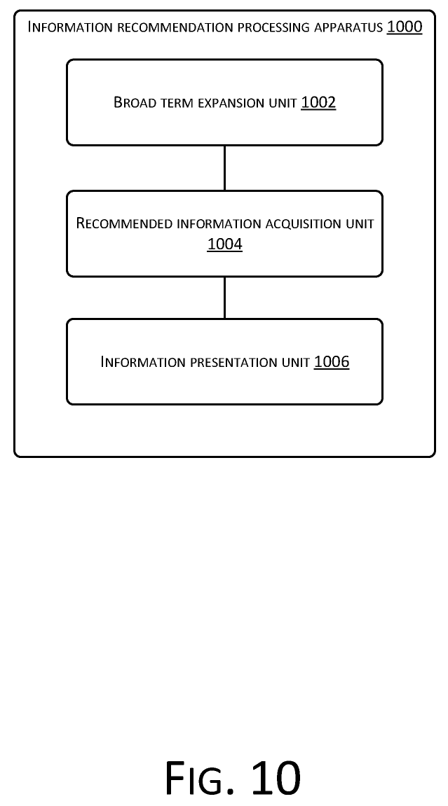

In another aspect, the present disclosure further provides an apparatus of processing information recommendation. FIG. 10 shows a diagram of a modular structure of an apparatus 1000 of processing information recommendation in accordance with an embodiment provided by the present disclosure. As shown in FIG. 10, the apparatus 1000 may include a broad term expansion unit 1002 used for expanding a broad search term into at least one search sentence based on a preconfigured information corpus after determining that an obtained search term is the broad search term; a recommended information acquisition unit 1004 used for obtaining recommended information that matches the search sentence from a selected information set; and an information presentation unit 1006 used for presenting at least one piece of the recommended information.

The processing apparatus of information recommendation provided in the present disclosure can expand a broad search term into at least one search sentence after determining that an obtained search term is the broad search term, obtain recommended information matching the search sentence from a selected information set, and present at least one piece of the recommended information. On the one hand, a search topic of a user can be preserved based on the originally broad search term. On the other hand, expanding the broad search term based on a provided information corpus can not only increase effective information of the broad search term, but also cause the expanded search sentence to be closer to information. Compared with methods that expand a broad search term based on a search log of a user and recommend precise information having a relatively small scope to the user in the existing technologies, the present embodiments can push recommended information that matches the search sentence to the user. The recommended information not only increases the space of selection for the user, but also provides further search guidance to the user.

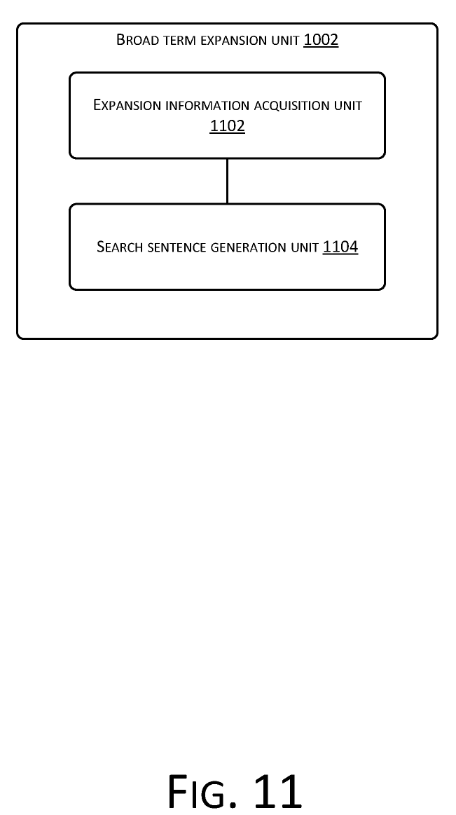

In implementations, FIG. 11 shows a diagram of a modular structure of the broad term expansion unit 1002 in accordance with an embodiment of the present disclosure. As shown in FIG. 11, the broad term expansion unit 1002 may include an expansion information acquisition unit 1102 used for extracting expansion information from the broad search term, the expansion information including at least one of the following types: a key term, an attribute term, weights associated with word segments, and a belonging category; and a search sentence generation unit 1104 used for expanding the broad search term into the at least one search sentence based at least in part on the preconfigured information corpus and the expansion information.

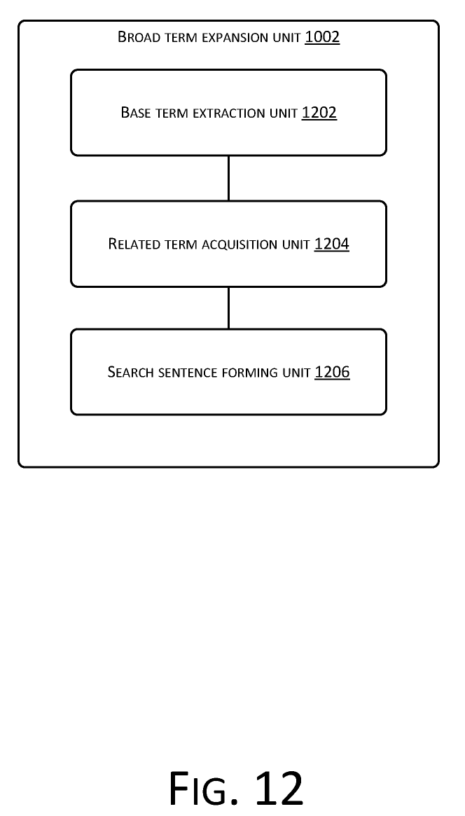

In implementations, FIG. 12 shows a diagram of a modular structure of the broad term expansion unit 1002 in accordance with another embodiment of the present disclosure. As shown in FIG. 12, the broad term expansion unit 1002 may include a base term extraction unit 1202 used for extracting at least one base term from word segments included in the broad search term; a related term acquisition unit 1204 used for obtaining related terms of the base term from the preconfigured information corpus; and a search sentence forming unit 1206 used for forming search sentences from the base term and the related terms.

In implementations, the base term may include synonym(s) and/or near-synonym(s) of the base term.

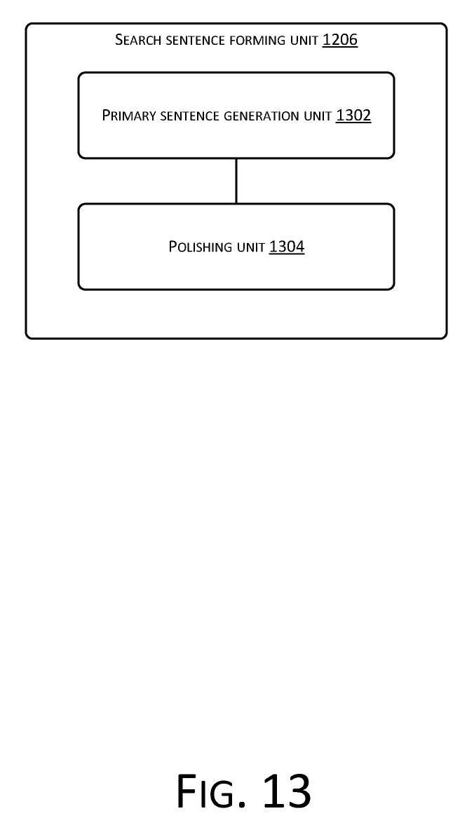

In implementations, FIG. 13 shows a diagram of a modular structure of the search sentence forming unit 1206 in accordance with an embodiment of the present disclosure. As shown in FIG. 13, the search sentence forming unit 1206 may include a primary sentence forming unit 1302 used for forming combinations of the base term and the related terms to generate primary sentences using a predefined language model; and a polishing unit 1304 used for polishing the primary sentences to generate search sentences.

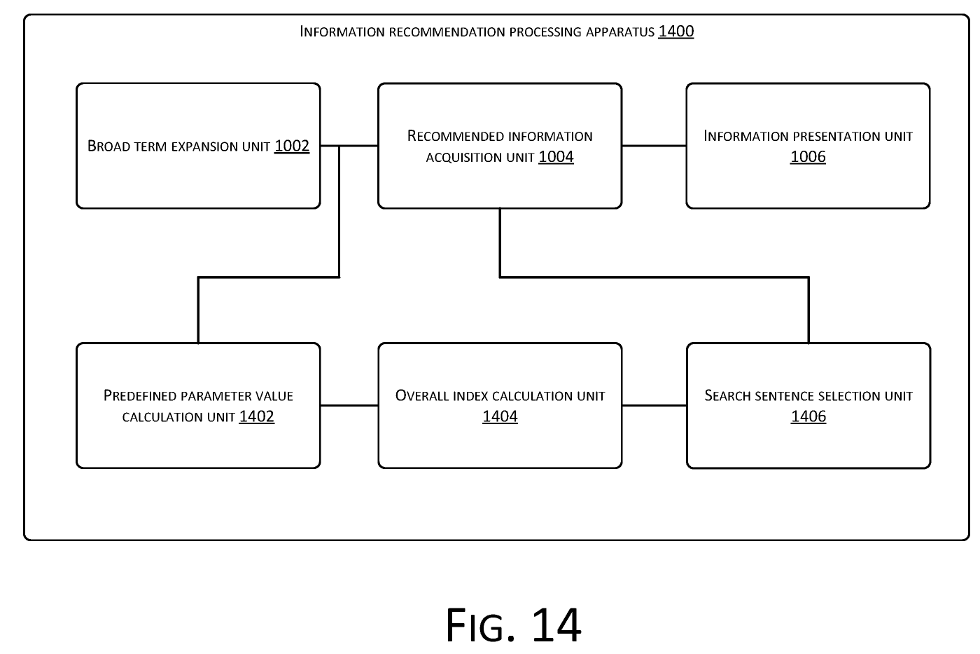

In implementations, FIG. 14 shows a diagram of a modular structure of an apparatus 1400 of processing information recommendation in accordance with another embodiment of the present disclosure. As shown in FIG. 14, the apparatus 1400 may further include a predefined parameter value calculation unit 1402 used for calculating parameter values of predefined parameters of the search sentences, the predefined parameters including at least one of the following types: a degree of semantic confusion, a user information matching index, and an information recall index; an overall index calculation unit 1404 used for calculating overall indices of the search sentences based on the parameter values and predefined weight indices of the predefined parameters; and a search sentence selection unit 1406 used for selecting target search sentence(s) from the at least one search sentence using predefined rule(s) based on the overall indices.

Correspondingly, the recommended information acquisition unit 1004 is further used for obtaining recommended information matching the target sentence(s) from the selected information set.

In implementations, the predefined rule(s) is/are configured as selecting target sentence(s) having an overall index greater than a first threshold value and/or being positioned prior to a second threshold value in a descending order of the overall indices, from the at least one search sentence.

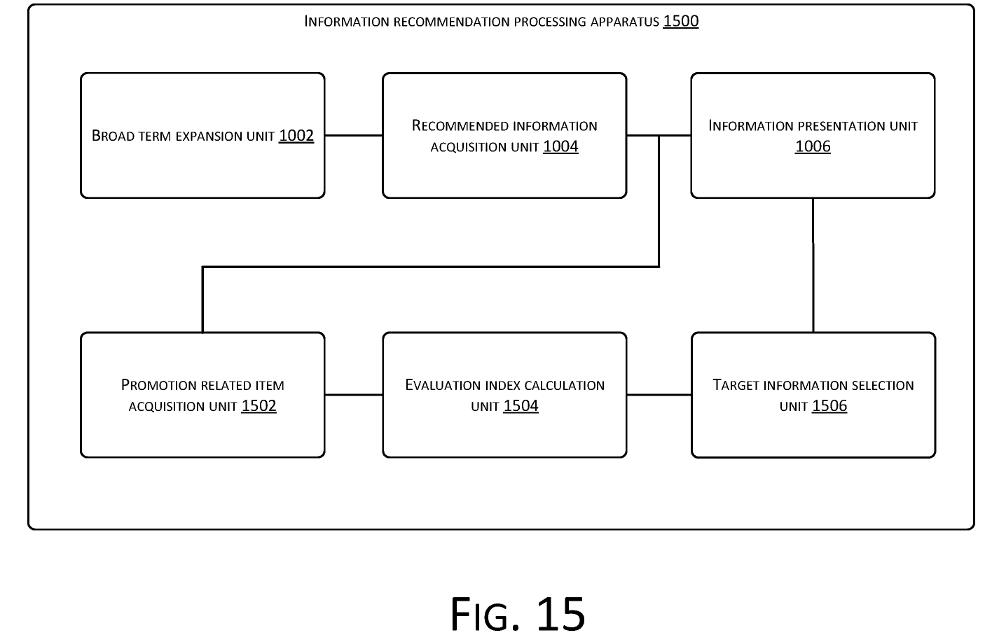

In implementations, FIG. 15 shows a diagram of a modular structure of an apparatus 1500 of processing information recommendation in accordance with another embodiment of the present disclosure. As shown in FIG. 15, the apparatus 1500 may further include a promotion related item acquisition unit 1502 used for obtaining promotion related items associated with the search sentence from the recommended information; an evaluation index calculation unit 1504 used for calculating evaluation indices of the recommended information and the promotion related items; and a target information selection unit 1506 used for selecting target information from the recommended information based on the evaluation indices of the recommended information and the promotion related items included in the recommended information.

In implementations, the information presentation unit 1006 is further used for presenting at least one piece of the target information and promotion related items included in the target information.

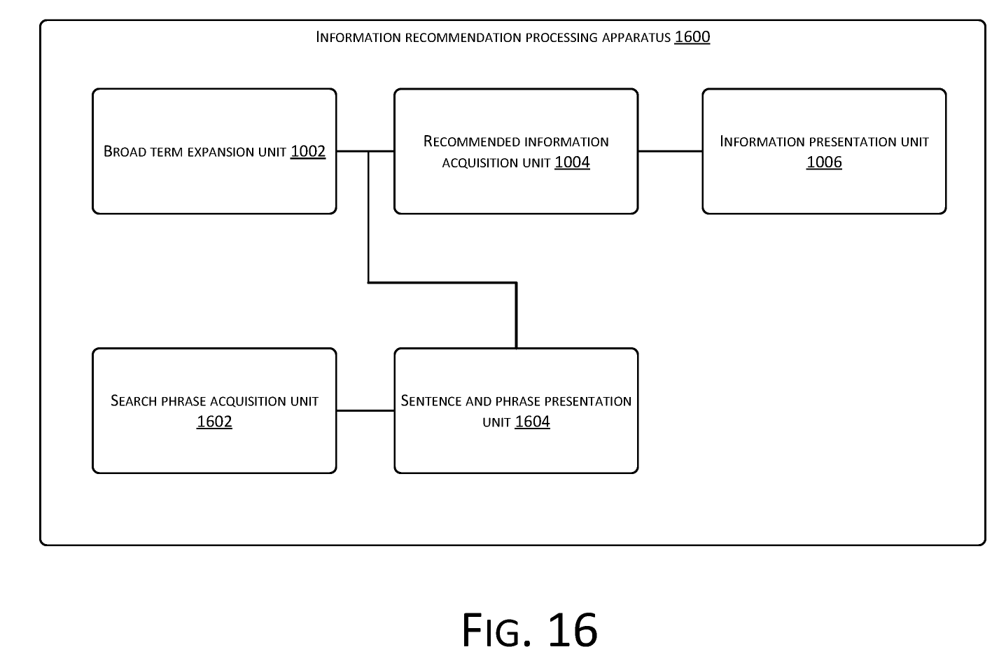

In implementations, FIG. 16 shows a diagram of a modular structure of an apparatus 1600 of processing information recommendation in accordance with another embodiment of the present disclosure. As shown in FIG. 16, the apparatus 1600 may further include a search phrase acquisition unit 1602 used for expanding the broad search term into at least one search phrase according to predefined expansion rule(s); and a sentence and phrase presentation unit 1604 used for presenting the search sentence and the search phrase.

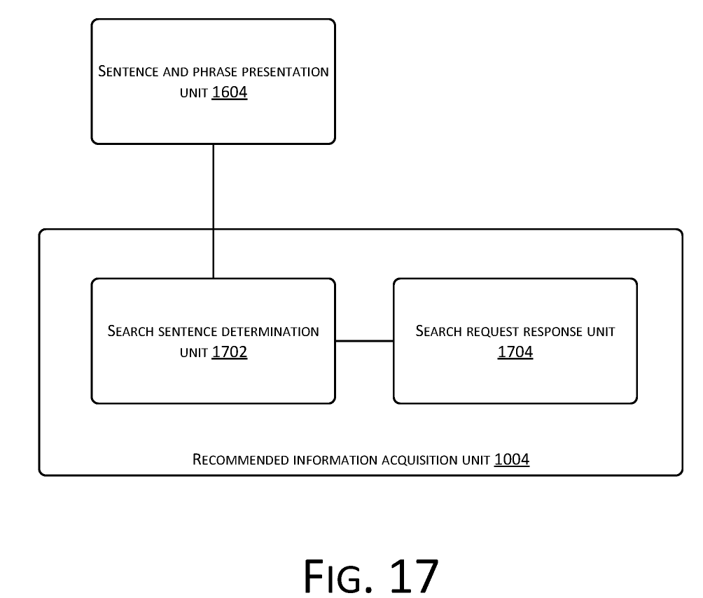

In implementations, FIG. 17 shows a diagram of a modular structure of the recommended information acquisition unit 1004 in accordance with an embodiment of the present disclosure. As shown in FIG. 17, the recommended information acquisition unit 1004 includes a search sentence determination unit 1702 used for receiving a search request and determining whether the search request includes the search sentence; and a search request response unit 1704 used for responding to the search request and obtaining the recommended information matching the search sentence from the selected information set if a determination result is affirmative.

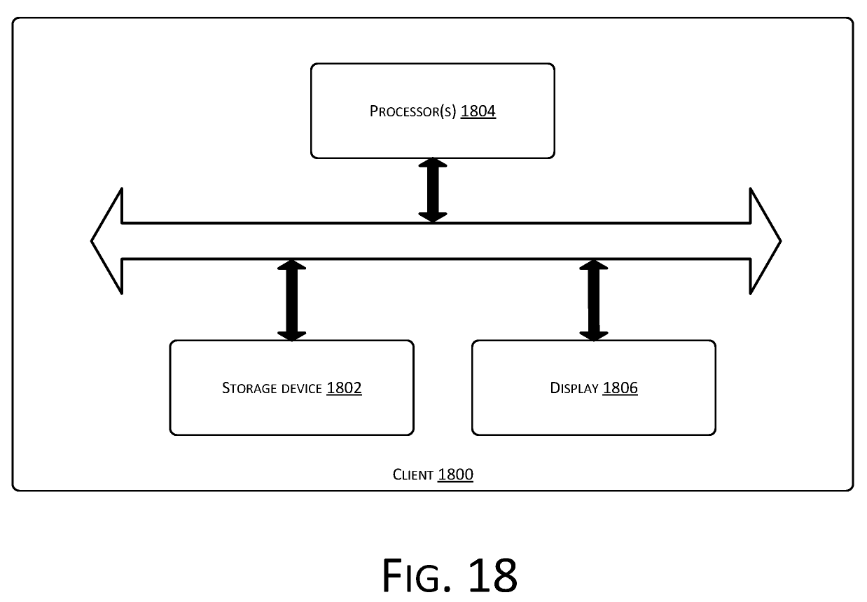

Finally, the present disclosure provides a client. FIG. 18 shows a diagram of a modular structure of a client 1800 in accordance with an embodiment of the present disclosure. As shown in FIG. 18, the client 1800 includes a storage device 1802 used for storing a preconfigured information corpus and storing a selected information set; processor(s) 1804 used for expanding a broad search term into at least one search sentence based on the preconfigured information corpus after determining that an obtained search term is the broad search term, and for obtaining recommended information that matches the search sentence from the selected information set; and a display 1806 used for presenting at least one piece of the recommended information.

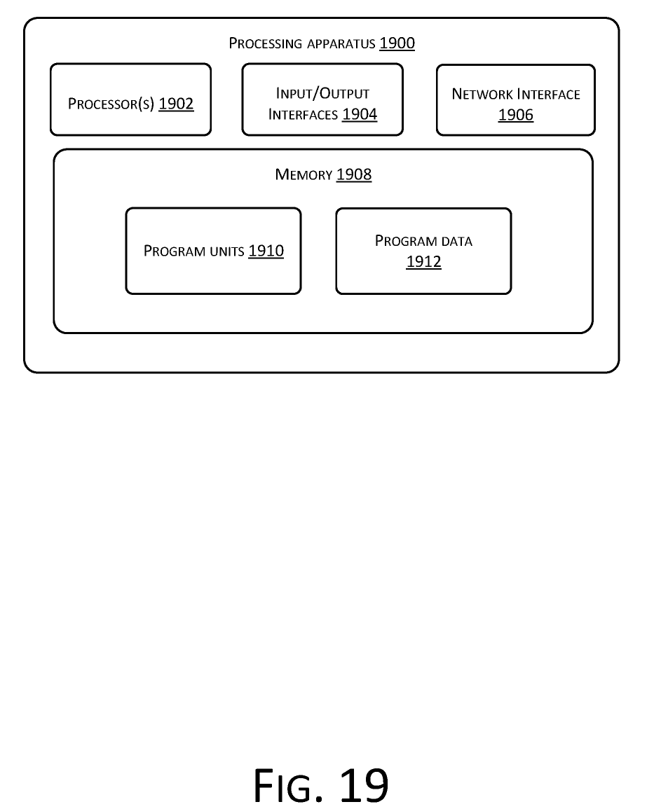

FIG. 19 shows a structural diagram of a processing apparatus 1900, such as the apparatuses described in FIGS. 10 and 14-16, in further detail. In implementations, the processing apparatus 1900 may include a computing device, such as a mobile terminal, or may be a portion of a computing device. By way of example and not limitations, the processing apparatus 1900 may include one or more processors 1902, an input/output interface 1904, a network interface 1906, and memory 1908.

The memory 1908 may include a form of computer readable media such as a volatile memory, a random access memory (RAM) and/or a non-volatile memory, for example, a read-only memory (ROM) or a flash RAM. The memory 1908 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1908 may include program units 1910 and program data 1912. The program units 1910 may include any of the units as described in the foregoing description.

Although the present disclosure describes data presentation, configuration and processing such as presenting recommended information, extracting expansion information, selecting data, etc., in the embodiments, the present disclosure is not limited to situations that completely satisfy programming language design standards or data described by the embodiments. Implementation solutions that are obtained after making modifications from certain page design languages or the descriptions of the embodiments can also achieve effects of implementations that are the same as, equivalent to, or close to those of the embodiments, or expected effects of implementations after the modifications are made. Apparently, even though the above data processing and determination methods are not used, the same application can also be implemented provided that the recommended information presentation, extracting expansion information extraction and data selection methods in the foregoing embodiments are fulfilled, and thus are not redundantly described herein.

Although the present disclosure provides operations of methods as shown in the embodiments or accompanying drawings, the methods may include more or fewer number of operations according to common practices or without the need of any creative effort. The orders of execution described in the embodiments of the present disclosure merely represent some of a plurality of orders of execution, and do not represent the only orders of execution. During a process of information recommendation or an execution of an apparatus, a method may be performed according to an order described in the embodiments or accompanying drawings, or may be performed in a parallel manner (for example, in an environment having parallel processing devices or multi-thread processing).

The units and apparatuses described in the foregoing embodiments can be implemented using computer chips or entities, or implemented by products having certain functionalities. For the sake of description, the foregoing apparatuses are divided into various modules by means of functions for separate descriptions. Apparently, the functions of the modules can be implemented in one or more software components and/or hardware components when the present disclosure is implemented. Apparently, a certain module unit described in the present disclosure can have a module with the same function to be implemented by multiple sub-modules or a combination of sub-modules.

Other than implementing a controller in a form of pure computer-readable programming codes, one skill in the art also understands that logical programming of method operations can be performed to cause a controller to implement the same functions in a form of logic gates, switches, application-specific integrated circuits, programming logical controllers, and embedded mini-controllers, etc. Therefore, this type of controller may be recognized as a type of hardware component. An internal portion thereof, including apparatuses used for implementing various functionalities, may also be recognized as an internal structure of the hardware component. Alternatively, the apparatus used for implementing the various functionalities can even be recognized as software components implementing the methods and an internal structure of the hardware component.

The present disclosure can be described in the context of computer-executable instructions executed by a computer, such as a program module. Generally, a program module includes a routine, a program, an object, a component, a data structure, etc., that performs a designated task or implements a designated abstract object type. The present disclosure can also be implemented in distributed computing environments. In these distributed computing environments, a remote processing device that is connected via a network can perform tasks. In a distributed computing environment, a program module can be located in local and remote computer-storage media including a storage device.

As can be seen from the above description, one skill in the art can clearly understand that the present disclosure can be implemented in a form of a software component with a necessary hardware platform. Based on this understanding, the essence of the technical solutions of the present disclosure or the portions that provide contributions to the existing technologies can be implemented in a form of a software product. This computer software product may be stored in storage media, such as ROM/RAM, a magnetic disk, an optical disk, etc., and includes instructions used for driving a computing device (which can be a personal computer, a mobile device, a server, or a networked device, etc.) to perform the method described in the embodiments or portions of the embodiments of the present disclosure.

The embodiments of the present disclosure are described in a progressive manner. The same or similar portions of the embodiments can be referenced with each other. Each embodiment places an emphasis differently from other embodiments. The present disclosure can be used in multiple general or specialized computing system environments or configurations, such as a personal computer, a server computer, a handheld device or portable device, a tablet device, a multi-processor system, a min-processor based system, a set top box, a programmable electronic device, a network PC, a mini-computer, a large-scale computer, and a distributed computing environment including any of the foregoing systems or devices.

Although the present disclosure is described using the embodiments, one of ordinary skill in the art understands that the present disclosure has a number of variations and changes without departing the spirit of the present disclosure. The appended claims are intended to include these variations and changes without departing the spirit of the present disclosure.

What is claimed is:

1. A method implemented by one or more computing devices, the method comprising:
expanding a search term into at least one search sentence based on a preconfigured information corpus;
obtaining recommended information matching the search sentence from a selected information set; and
providing at least one piece of the recommended information for display.

2. The method of claim 1, wherein expanding the search term into the at least one search sentence comprises:
extracting an expansion information from the search term, the expansion information including at least one of a key term, an attribute term, weights associated with word segments, and a belonging category; and
expanding the search term into the at least one search sentence based at least in part on the preconfigured information corpus and the expansion information.

3. The method of claim 1, wherein expanding the search term into the at least one search sentence comprises:
extracting at least one base term from word segments included in the search term;
obtaining related terms of the base term from the preconfigured information corpus; and
combining the base term and the related terms into the search sentence.

4. The method of claim 3, wherein the base term comprises a synonym or a near-synonym of the word segments.

5. The method of claim 3, wherein combining the base term and the related terms into the search sentence comprises:
combining the base term and the related terms to generate a primary sentence using a predefined language model; and
polishing the primary sentence to generate the search sentence.

6. The method of claim 3, wherein after expanding the search term into the at least one search sentence, the method further comprises:
calculating parameter values of predefined parameters of the search sentence, the predefined parameters including at least one of: a degree of semantic confusion, a user information matching index, and an information recall index;
calculating an overall index of the search sentence based on the parameter values and predefined weight indices of the predefined parameters; and
selecting a target sentence from the at least one search sentence based on the overall index using a predefined rule, wherein obtaining the recommended information matching the search sentence from the selected information set correspondingly comprises obtaining recommended information that matches the target search sentence from the selected information set.

7. The method of claim 6, wherein the predefined rule comprises selecting a target search sentence having an overall index greater than a first threshold value and/or ranked prior to a second threshold in a descending order of the overall index from the at least one search sentence.

8. The method of claim 1, wherein: after obtaining the recommended information matching the search sentence from the selected information set, the method further comprises:
extracting promotion related items having an association relationship with the search sentence from the recommended information;
calculating evaluation scores of the recommended information and the promotion related items; and
selecting target information from the recommended information based on the evaluation scores of the recommended information and the promotion related items included in the recommended information.

9. The method of claim 8, wherein presenting the at least one piece of the recommended information comprises presenting the at least one piece of the recommended information and the promotion related items included in the recommended information.

10. The method of claim 1, wherein: after expanding the search term into the at least one search sentence, the method further comprises:
expanding the search term into at least one search phrase based on a predefined expansion rule; and
presenting the search sentence and the search phrase.

11. The method of claim 10, wherein obtaining the recommended information matching the search sentence from the selected information set comprises:
receiving a search request, and determining whether the search request includes the search sentence; and
responding to the search request, and obtaining the recommended information matching the search sentence from the selected information set if a determination result is affirmative.

12. An apparatus comprising:
one or more processors;
memory;
a term expansion unit stored in the memory and executable by the one or more processors to expand a search term into at least one search sentence;
a recommended information acquisition unit stored in the memory and executable by the one or more processors to obtain recommended information matching the search sentence from a selected information set; and
an information presentation unit stored in the memory and executable by the one or more processors to provide at least one piece of the recommended information for presentation.

13. The apparatus of claim 12, wherein the term expansion unit comprises:
an expansion information acquisition unit to extract expansion information from the search term, the expansion information including at least one of: a key term, an attribute term, weights associated with word segments, and a belonging category; and
a search sentence generation unit used to expand the search term into the at least one search sentence based at least in part on the preconfigured information corpus and the expansion information.

14. The apparatus of claim 12, wherein the term expansion unit comprises:
a base term extraction unit to extract at least one base term from word segments included in the broad search term;
a related term acquisition unit to obtain related terms of the base term from the preconfigured information corpus; and
a search sentence forming unit to form search sentences from the base term and the related terms.

15. The apparatus of claim 14, wherein the search sentence forming unit comprises:
a primary sentence forming unit to form combinations of the base term and the related terms using a predefined language model to generate primary sentences; and
a polishing unit used to polish the primary sentences to generate search sentences.

16. The apparatus of claim 14, further comprising:
a predefined parameter value calculation unit used for calculating parameter values of predefined parameters of the search sentences, the predefined parameters including at least one of: a degree of semantic confusion, a user information matching index, and an information recall index;
an overall index calculation unit used for calculating overall indices of the search sentences based on the parameter values and predefined weight indices of the predefined parameters; and
a search sentence selection unit used for selecting target search sentences from the at least one search sentence using a predefined rule based on the overall indices.

17. The apparatus of claim 12, further comprising:
a promotion related item acquisition unit used for obtaining promotion related items associated with the search sentence from the recommended information;
an evaluation index calculation unit used for calculating evaluation indices of the recommended information and the promotion related items; and
a target information selection unit used for selecting target information from the recommended information based on the evaluation indices of the recommended information and the promotion related items included in the recommended information.

18. The apparatus of claim 12, further comprising:
a search phrase acquisition unit used for expanding the search term into at least one search phrase according to a predefined expansion rule; and
a sentence and phrase presentation unit used for presenting the search sentence and the search phrase.

19. The apparatus of claim 18, wherein the recommended information acquisition unit comprises:
a search sentence determination unit used for receiving a search request and determining whether the search request includes the search sentence; and
a search request response unit used for responding to the search request and obtaining the recommended information matching the search sentence from the selected information set if a determination result is affirmative.

20. One or more computer-readable media storing executable instructions that, when executed by one or more processors, cause the one or more processors to perform acts comprising:
receiving a search term from a user;
presenting one or more search sentences and one or more search phrases to a user in response to receiving the search term;
receiving a selection of a search sentence from the user; and
presenting recommended information that matches the selected search sentence.
